(19) United States
(12) Patent Application Publication
(10) Pub. No.: US 2017/0372247 A1
(43) Pub. Date: Dec. 28, 2017

(54) METHODS, SYSTEMS, AND ARTICLES OF MANUFACTURE FOR IMPLEMENTING SOFTWARE APPLICATION DEVELOPMENT AND RELEASES

(71) Applicant: INTUIT INC., Mountain View, CA (US)

(72) Inventors: Richard Tauber, Oceanside, CA (US); Kristin A. Centofante, Redwood City, CA (US); Ajithkumar Kattil, Milpitas, CA (US); Chetan Deepak Desai, Poway, CA (US); Thomas W. Whitcomb, Solana Beach, CA (US)

(73) Assignee: INTUIT INC., Mountain View, CA (US)

(21) Appl. No.: 15/192,949

(22) Filed: Jun. 24, 2016

(51) Int. Cl. G06Q 10/06; G06F 9/44; G06F 9/445; G06F 11/36

(52) U.S. Cl. CPC G06Q 10/06316; G06F 11/3672; G06F 11/3668; G06F 8/30; G06F 8/60; G06F 8/70

(57) ABSTRACT

Various aspects described herein are directed to a system that develops and manages releases of software applications. The system includes a server-side branch management module to automatically create one or more branches for deployment of a software application release, a deployment repository to store one or more box sets for a plurality of artifacts for the software release, and a code repository to store the plurality of artifacts. The system may further include a release management module configured to manage continuing releases of the software application, a continuous deployment dashboard module configured to receive the plurality of box sets from the deployment repository, and one or more development modules configured to create or modify at least some artifacts of the plurality of artifacts. The plurality of artifacts are automatically tagged with respective packaging types for automatic generation of the plurality of box sets.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A software release life cycle of a software application includes multiple stages from a series of development releases that occur nightly, through the alpha release, the beta release, the release to manufacturing, the release to production, etc. and thus requires a joint effort involving multiple teams such as the development team, the quality team, various test teams, the database team, the marketing team, the finance team, the documentation team, etc.

A software release life cycle thus faces several challenges before the software application goes gold. For example, different teams may use different tools or systems in different environments in an independent manner. In addition, various teams may require different pieces of information or code to accomplish their respective mission objectives. For example, different test teams may run different tests to ensure that the software application meets their respective goals or standards; and each engineer in the development team may work on individual pieces of code that are to be integrated together to form the entire software application and thus impact one another. A conventional software release therefore requires a lot of manual and tedious efforts in creating, maintaining, bookkeeping, communicating, and coordinating various intermediate products among these various teams and is thus error prone and requires a substantial amount time to complete each stage during the software release life cycle. In fact, the mere identification and collection of individual artifacts of the correct version from various engineers of each team may require repeated efforts and often falls short.

Therefore, there exists a need for a method, system, and computer product for implementing software development and releases to address at least the aforementioned challenges.

### SUMMARY

Disclosed are various embodiments relating to methods, systems, and articles of manufacture for implementing software development and releases. One or more embodiments are directed at a method for implementing software development and releases for software applications including, for example, tax preparation software product or software service, financial management software product or software service, payroll software product or software service, accounting software product or software service, etc. In these embodiments, one or more server computers that are connected to a plurality of client computing devices via one or more computer networks and comprise at least a branch management module and a release management module that are stored at least partially in memory of the one or more server computers.

These one or more servers perform a process that comprises initiating a software application release for a software application at least by creating a branch, at the branch management module, for the software application release. A plurality of artifacts may be automatically identified by the one or more servers for the software application release based in part or in whole upon a plurality of packaging types associated with the plurality of artifacts. The plurality of artifacts may be automatically packaged into one or more box sets for deployment into one or more corresponding environments for the software application release. The one or more box sets may be deployed into the one or more corresponding environments by the one or more servers to complete the software application release.

In some of these embodiments, the branch may be automatically identified with a common branch identifier visible to the plurality of client computing systems by the one or more servers; a project may be generated for the software application release; and a build process may be initiated for the project by using a project object model. In addition, a snapshot may be generated by performing a database query in response to a commit command to store a state of at least some artifacts of the plurality of artifacts; and the at least some artifacts may be verified at least by performing an error detection process prior to completion of the commit command.

In some of the immediately preceding embodiments, one or more branches may be automatically created for the software application release in response to one or more requests from the plurality of client computing systems; and at least one newly created artifact of the plurality of artifacts may be automatically tagged with a packaging type.

In some embodiments, the release management module hosted on the one or more servers manage the software application release by using at least the one or more box sets. In some of these embodiments, a model driven deployment for the software application release may be performed at least by generating one or more release models or one or more release packages; and at least one artifact of the plurality of artifacts or at least one box set of the one or more box sets may be identified with a packaging type. In addition, software resources for the software application release may be generated; and the release management module may process the software resources for the software application release.

In some of the immediately preceding embodiments, data or information may be accessed by a common data access mechanism hosted on the one or more servers for the software application release; and dependencies among at least some artifacts of the plurality of artifacts may be generated and tracked.

In some embodiments, the software application may be developed at least by creating one or more artifacts in the plurality of artifacts in a development environment at one or more code development modules coupled to the plurality of client computing systems. In some of these embodiments, one or more packaging types may be associated with the one or more artifacts created in the development environment; a build process may be initiated for the project; and one or more testing environments may be set up. In addition, one or more tests may be identified or created; the one or more tests may then be executed in the one or more testing environments; and hierarchies for at least the one or more artifacts may be generated and maintained.

In some embodiments, software testing may be performed in one or more testing environments. In addition, one or more requirements for the software application may be identified; and one or more changes from a previous software application release of the software application prior to the software application release may be identified. In some of these embodiments, a test strategy and a test plan may be determined; one or more tests may be determined based in whole or in part upon the test strategy and the test plan; and a plurality of test cases and a plurality of test procedures may be determined for the one or more tests. In addition, the one or more tests may then be executed in the one or more testing environment; results of executing the one or more tests may be analyzed; one or more bugs may be fixed; and the one or more tests may then be closed.

Certain embodiments are directed at an apparatus for implementing various processes described herein for managing the development and releases of various software applications including, for example, for tax preparation software product or software service, financial management software product or software service, payroll software product or software service, accounting software product or software service, etc. More details about the apparatus for implementing various processes will be described in some of the subsequent paragraphs with reference to one or more drawing figures.

In these embodiments, the system may include one or more server computers connected to a plurality of client computing systems via one or more computer networks; a branch management module operatively coupled to a release management module and configured at least to automatically create one or more branches for deployment of a software application release, the branch management module and the release management module stored at least partially in memory of the one or more server computers; at least one persistent deployment repository accessible by at least the branch management module and the release management module and configured to store link structures corresponding to a plurality of artifacts for the software application release; and at least one persistent code repository accessible by at least the branch management module and the release management module and configured to store the plurality of artifacts.

In some of these embodiments, the system may further include a release management module hosted on at least one server computer of the one or more server computers and configured to manage continuing releases of the software application. The branch management module may be further configured to generate a first box set and to identify link structures corresponding to the plurality of artifacts for the software application release in some of these embodiments.

In addition or in the alternative, the branch management module may be further configured to generate a plurality of box sets from the first box set and to identify respective link structures corresponding to artifacts in each of the plurality of box sets based in part or in whole upon one or more integration platforms or environments for the deployment of the software application release. In some of these embodiments, the system may further include a continuous deployment dashboard module configured to receive the plurality of box sets from the at least one deployment repository; and an enterprise continuous deployment module operatively coupled with the at least one persistent code repository and configured to receive the plurality of box sets based in part or in whole upon one or more acts performed by the continuous deployment dashboard module. The enterprise continuous deployment module is further configured to deploy the plurality of box sets to one or more enterprise services environments comprising at least one of a development environment, a quality check environment, a system environment, a Web environment, a manufacturing environment, or a performance test environment in some of the immediately preceding embodiments.

In some embodiments, the release management module in the system may include at least one of a release builder module that is configured to generate one or more models or packages for the software application release; a package identifying module that is configured to identify the plurality of artifacts with their respective packaging types; a resource generator module that is configured to generate software resources for the software application release; a software resource processing module that is configured to process at least some of the software resources; a data access module that is configured to provide one or more common data access mechanisms to access data or information related to the software application release; or a dependency module that is configured to generate and track dependencies among at least some of the plurality of artifacts.

In some embodiments, the branch management module in the system may further include at least one of a snapshot module that is configured to take one or more snapshots of a state of a branch for the software application release upon an invocation of a commit command received from one or more modules operating on the branch; a data verification module that is configured to verify at least a newly created artifact or a modified artifact in the plurality of artifacts upon an invocation of the commit command received from the one or more modules operating on the branch and before storing the newly created artifact or the modified artifact in the at least one persistent code repository; a branching module that is configured to generate a project for the software application release, to create a branch with a common branch identifier, and to initiate a build process for the project with a project object model; a merge module that is configured to merge the newly created artifact or the modified artifact back into the one or more server computers; or an automatic tagging module that is configured to automatically tag at least some artifacts of the plurality artifacts with respective identifiers or package types.

In some embodiments, the system may further include one or more code development modules that are operatively coupled with at least the branch management module and are configured to reside on or to interact with the plurality of client computing systems to create or modify at least some artifacts of the plurality of artifacts. In some of these embodiments, a code development module may include at least one of a packaging identification module that is configured to associate a packaging type with the box set or a newly created artifact of the plurality of artifacts; a project object model module that is configured to generate a project and initiate a build process for the project with a project object model; an information generation and retrieval module that is configured to generate or retrieve object information and build information for the project object model; a build module that is configured to generate a build process and to perform version control, one or more code or program analyses, compilation, or interpretation for at least some artifacts of the plurality of artifacts for the build process; one or more test modules that are configured to automatically generate one or more tests and to set up one or more testing environments without relying on customizing the build process for the one or more tests; or a code hierarchy module that is configured to generate and maintain hierarchies indicating parent-child relationships among at least some artifacts of the plurality of artifacts.

Certain embodiments are directed at an article of manufacture having stored thereupon a sequence of instructions which, when executed by a mobile computing or communication device, causes the mobile computing or communication device to perform various processes or to invoke various modules described herein. More details about the article of manufacture will be described in some of the subsequent paragraphs with reference to one or more drawing figures. Some of the aforementioned embodiments are directed to various computer program products and mechanisms for software products or services including one or more of catalog services, order services, subscription services, billing services, account services, entitlement services for tax preparation software product or software service, financial management software product or software service, payroll software product or software service, accounting software product or software service, etc. Some other embodiments are directed to various computer program products and mechanisms for financial management, to the extent that it is severable from any tax strategy or does not limit the use of any tax strategy by any taxpayer or tax advisor.

Further details of various embodiments of the invention are described in the Detailed Description section with reference to respective figures.

### BRIEF DESCRIPTION OF THE FIGURES

The drawings illustrate the design and utility of various embodiments. It should be noted that the figures are not drawn to scale and that elements of similar structures or functions are represented by like reference numerals throughout the figures. In order to better appreciate how to obtain the above-recited and other advantages and objects of various embodiments, a more detailed description of the inventions briefly described above will be rendered by reference to specific embodiments thereof, which are illustrated in the accompanying drawings. Understanding that these drawings depict only certain embodiments and are not therefore to be considered limiting of its scope, certain embodiments will be described and explained with additional specificity and detail through the use of the accompanying drawings in which:

FIG. 1A illustrates a high level block diagram of a system for implementing software development and releases in one or more embodiments.

FIG. 1B illustrates more details about an example code repository illustrated in the high level block diagram in FIG. 1A of a system for implementing software development and releases in one or more embodiments.

FIG. 1C illustrates more details about an example continuous development dashboard module illustrated in the high level block diagram in FIG. 1A of a system for implementing software development and releases in one or more embodiments.

FIG. 1D illustrates more details about an example enterprise continuous deployment module illustrated in the high level block diagram in FIG. 1A of a system for implementing software development and releases in one or more embodiments.

FIG. 1E illustrates more details about an example of the release management modules illustrated in the high level block diagram in FIG. 1A of a system for implementing software development and releases in one or more embodiments.

FIG. 1F illustrates more details about the high level block diagram in FIG. 1A of a system for implementing software development and releases and some example modules as well as their functions in one or more embodiments.

FIG. 1G illustrates more details about the high level block diagram in FIG. 1A of a system for implementing software development and releases and some other example modules as well as their functions in one or more embodiments.

FIG. 1H illustrates more details about an example of test modules in a system for implementing software development and releases in one or more embodiments.

FIG. 1I illustrates a high level system diagram of a system that implements software development and releases in some embodiments.

FIG. 2A illustrates a high level block diagram of a branch management module in a system for implementing software development and releases in one or more embodiments.

FIG. 2B illustrates a high level block diagram of the enterprise continuous deployment module in a system for implementing software development and releases in one or more embodiments.

FIG. 2C illustrates more details about the deployment repository in a system for implementing software development and releases in one or more embodiments.

FIG. 2D illustrates more details about a process for determining common identifiers for branches and its interactions with various repositories in a system for implementing software development and releases in one or more embodiments.

FIG. 3A illustrates a graphical example of the branch management module in a system for implementing software development and releases in one or more embodiments.

FIG. 3B illustrates an example of the operations of a release management module in a system for implementing software development and releases in one or more embodiments.

FIG. 3C illustrates an example of the operations of a branch management module in a system for implementing software development and releases in one or more embodiments.

FIG. 3D illustrates an example of a sign-off user interface for a CTO continuous deployment dashboard in a system for implementing software development and releases in one or more embodiments.

FIG. 3E illustrates an example of a CTO continuous deployment dashboard box set in a system for implementing software development and releases in one or more embodiments.

FIG. 4 illustrates a block diagram of an illustrative computing system suitable for implementing software development and releases described herein.

### DETAILED DESCRIPTION OF ILLUSTRATED EMBODIMENTS

Some embodiments are directed at a method or system that implement software development and releases. Various techniques described herein invoke a branch management module to automatically and centrally manage branching techniques and strategy of a software release life cycle of a software application. For example, a branch management module may automatically create a master branch and one or more additional branches off the master branch and assign corresponding identifiers for such automatically created branches for one or more teams of engineers or developers to collaborate on the software application. These techniques also track the generation and modification of various artifacts during the software release life cycle and automatically identify such artifacts or versions thereof with packaging identifiers or tags. The pertinent artifacts for a release of the software application may be automatically retrieved, and these techniques automatically classify or categorize these pertinent artifacts to generate one or more box sets to capture these pertinent artifacts. A continuous deployment module may deploy these one or more box sets to one or more corresponding environments.

One of the advantages of these techniques described herein is that computational resource utilization is reduced or minimized because the generation and use of one or more box sets alleviate the need to rewrite all pertinent artifacts in one or more packages for a release. In addition, generating a box set to include links or references to artifacts is more efficient and consumes far less computational resources than generating one or more packages to include these pertinent artifacts for a release.

Another advantage of these techniques described herein is that these techniques described herein release a software application in the form of one or more box sets that include links or references to the pertinent artifacts to one or more deployment environments. Deploying in the form of one or more box sets consumes much less network resources as well as runtime to process these one or more box sets and memory footprint occupied by at least these one or more box sets that are much smaller in size than any packages storing artifacts.

Another advantage of these techniques described herein is the improved scalability, stability, and reliability of developing and managing software releases by using various modules described herein to streamline the entire development, testing, and release processes that eliminate or at least reduce possible errors that conventional approaches are impossible to avoid.

Various embodiments will now be described in detail with reference to the drawings, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, various embodiments encompass present and future known equivalents to the components referred to herein by way of illustration.

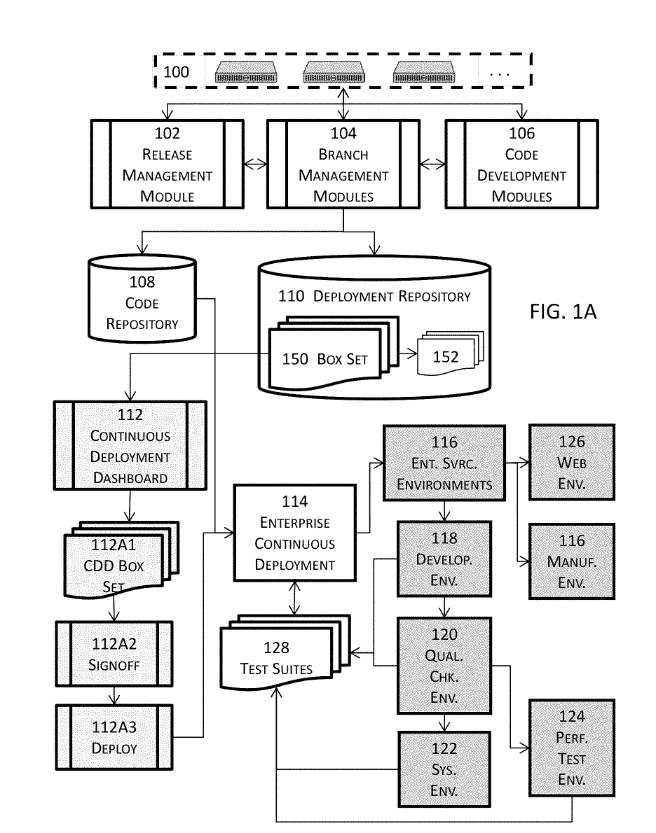

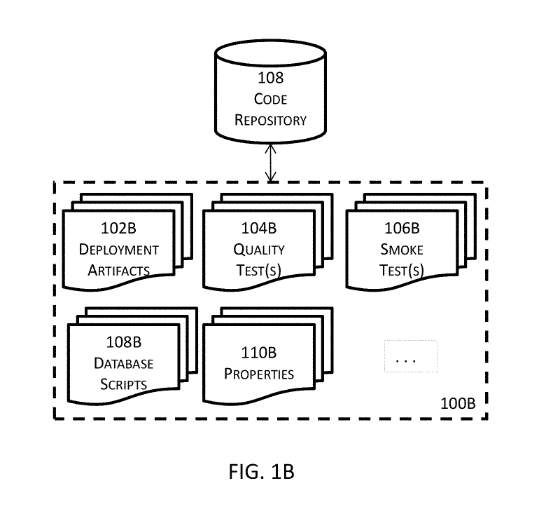

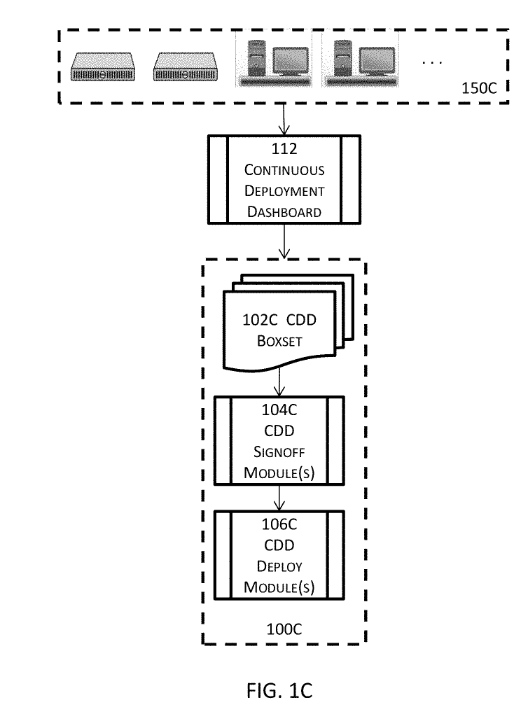

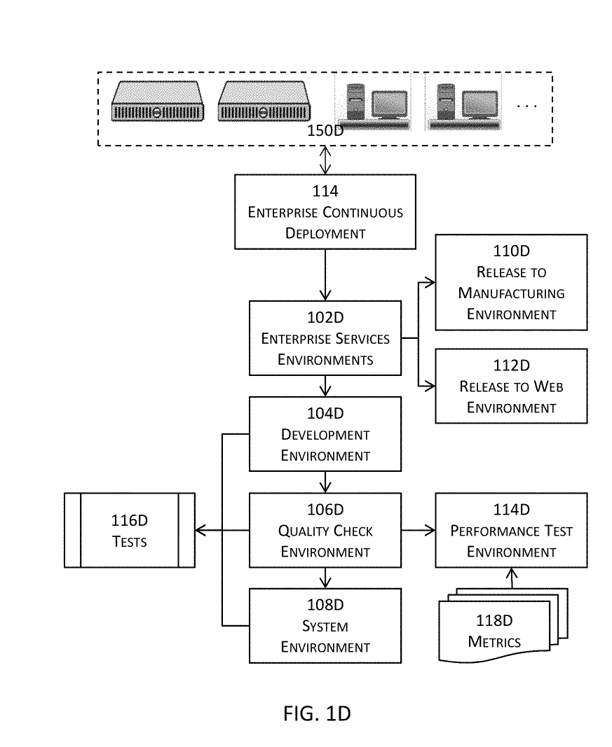

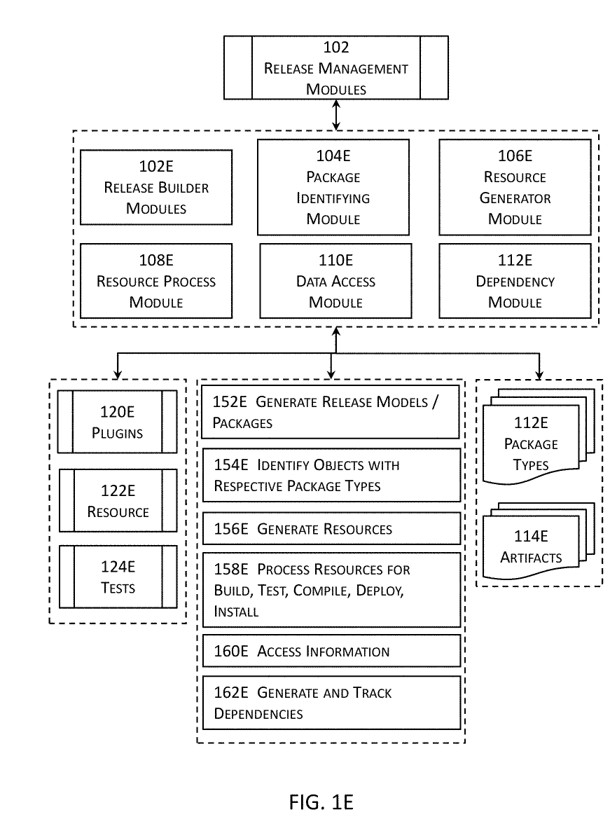

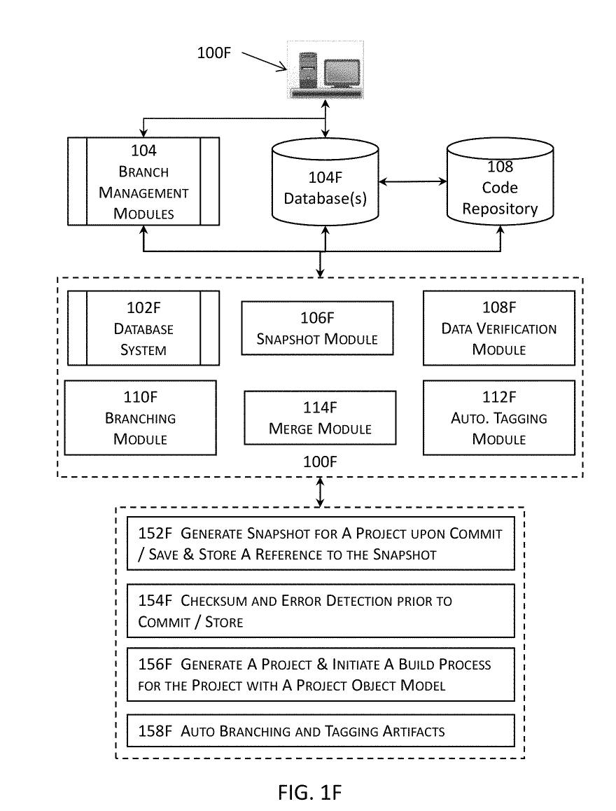

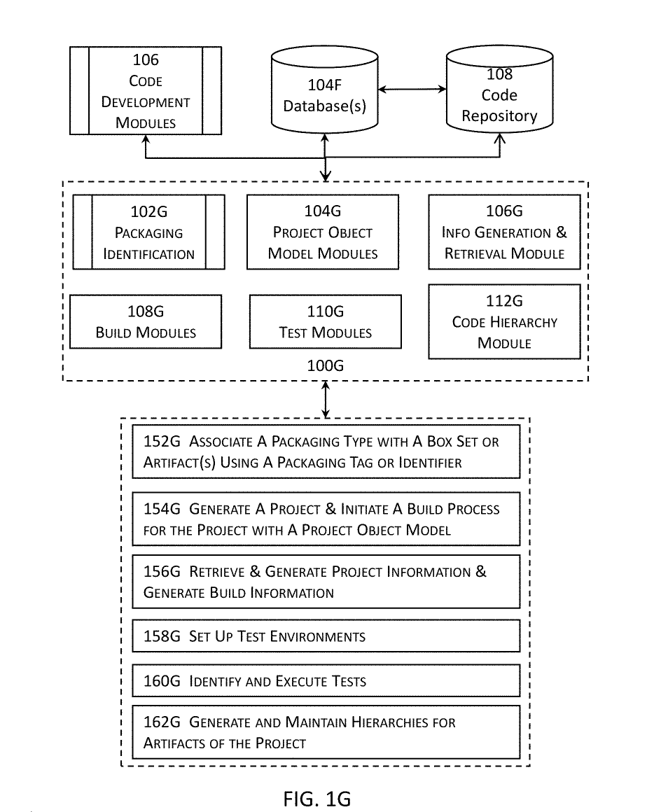

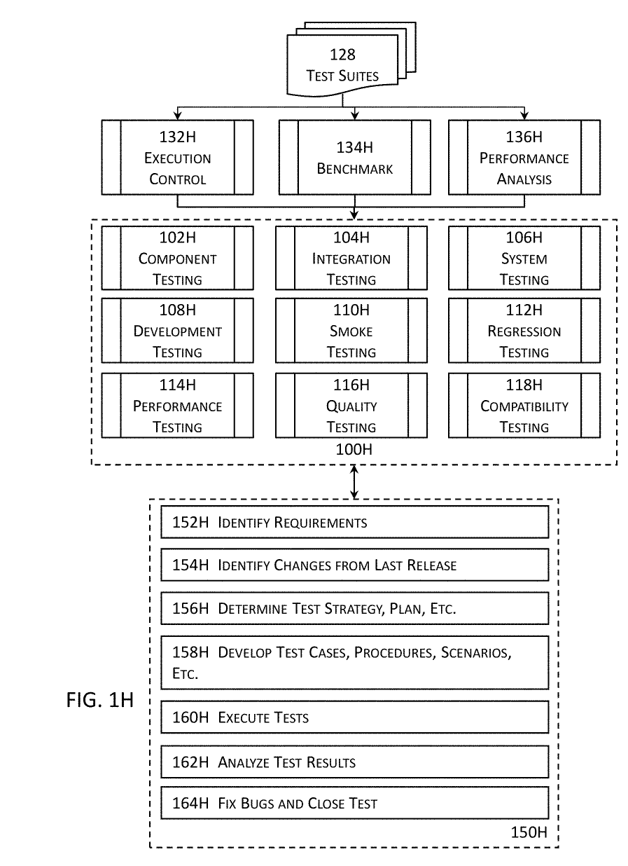

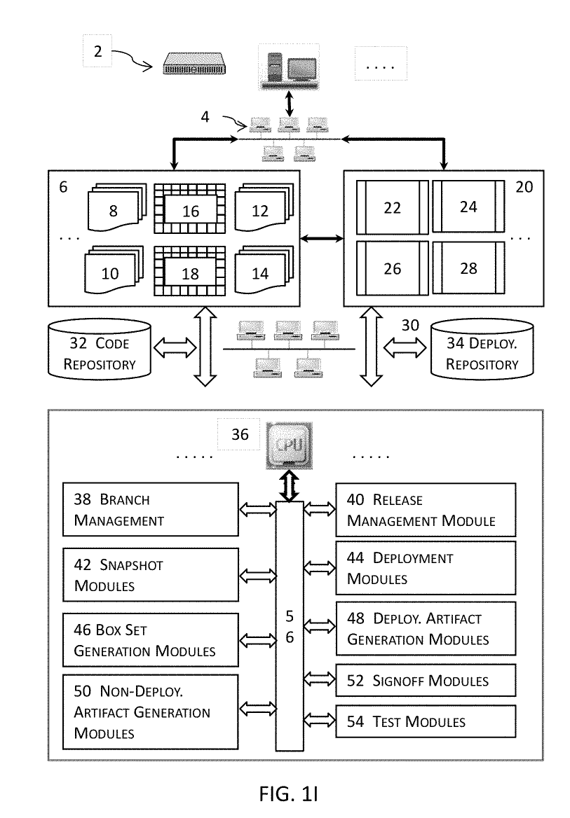

FIG. 1A illustrates a high level block diagram of a system for implementing software development and releases in one or more embodiments. In these embodiments, a plurality of computing systems 100 operated by various members among multiple teams may access a release management module 102 that controls and manages various aspects of multiple releases of a software application from the pre-alpha release all the way through the production release. The plurality of computing systems 100 may also access a branch management module 104 that generates, controls, and manages, for a software application release life cycle, a master branch with a unique master identifier for the release of a software application as well as a plurality of additional branches such as one or more feature branches, one or more release branches, etc. that bifurcate from the master branch.

The identification of each branch is also subject to the control and management of the branch management module 104 so that possible conflicts may be eliminated, and versioning of any aspects of the software application may be under control. These identifications of branches may be stored in a branching repository (not shown) that is also accessible by the release management module 102 and the one or more code development modules 106 for integration with the branch management module 104 as well as the deployment modules (e.g., the continuous deployment dashboard 112, the enterprise continuous deployment module 114, etc.) The branch management module 104 may track some or all deployable or non-deployable artifacts and function in tandem with the release management module 102 to fill or augment the box set (e.g., 150) to include everything (e.g., artifacts) to support a deployment.

In addition, the plurality of computing systems 100 access one or more code development modules 106 that are used to create, control, or manage deployable artifacts included in one or more releases, non-deployable artifacts that are not included in the one or more releases but are for reference purposes. The branch management module 104 is communicably coupled with the release management module 102 and the one or more code development modules 106 to collaboratively package and store a release of a software application into one or more box sets 150 including information of a plurality of artifacts 152 into a deployment repository 110.

In some embodiments, a box set 150 and hence each artifact of the plurality of artifacts may include references (e.g., pointers, link structures, symbolic links, uniform resource locators, uniform resource identifiers, etc.) to the contents (e.g., artifacts) therein, rather than storing the actual contents (e.g., artifacts) in the box set or a set of artifacts. In these embodiments, the actual contents are stored in the code repository 108 that is also coupled with the branch management module 104, rather than in the deployment repository 110. In some embodiments, either or both of the code repository 108 and the deployment repository 110 is a Web-based source control repository hosting service that offers distributed version control and source code management functionalities as well as role-based features.

In some embodiments, the branch management module 104 or the release management module 102 may identify and categorize artifacts required or desired to support a deployment into separate sets of pertinent artifacts in the form of a box set 150. For example, the artifacts may be categorized or grouped into the box set 150 that may further include the set of artifacts for quality tests, the set of artifacts for database scripts and schemas, the set of artifacts for smoke tests, and the set of artifacts for properties (e.g., global properties, application configuration properties, etc.). For example, the box set 150 in the deployment repository 110 may include all the desired or required artifacts to be released for the version of the software application. In this example, the branch management module 104 or the release management module 102 may group or categorize the plurality of artifacts into a first box set for the artifacts for quality tests, a second box set for the artifacts for database scripts and schemas, a third box set for the artifacts for smoke tests, and a fourth box set for the artifacts for properties based in part or in whole upon the relations among these artifacts.

When a version of a software application is to be released, the branch management module 104 creates and stores a box set 150 that includes a plurality of artifacts 152 in the deployment repository 110 which is further communicably coupled with a continuous deployment dashboard (CDD) 112. The continuous deployment dashboard 112 may include a collection of data (e.g., real-time data) that various users may access to review reports on various aspects of the software application (e.g., code quality, operational performance, etc.)

In some embodiments, the continuous deployment dashboard 112 may receive the box set 150 as a CDD box set 112A1. The CDD box set 112A1 may be forwarded to a signoff process 112A1 that verifies whether each set of artifacts is correct or includes the desired or required artifacts. Once the CDD box set 112A1 is signed off at 112A1, the CDD box set 112A1 may be forwarded to the enterprise continuous deployment module 114. enterprise continuous deployment module 114 includes a module that enables developers to integrate various pieces of artifacts into a shared repository (e.g., the deployment repository 110 or the code repository 108). The enterprise continuous deployment module 114 verifies each check-in of pieces of artifacts by an automated build, execution of individual component tests, and/or code coverage thresholds allowing multiple teams or members to detect problems with the software application early.

The enterprise continuous deployment module 114 parses the references to the artifacts in the CDD boxset 112A1 and obtains the artifacts from the code repository 108. Moreover, the enterprise continuous deployment module 114 may include parameters for various tests or test suites 128. In addition, the enterprise continuous deployment module 114 then disseminates the box set as well as the artifacts from the code repository 108 to the enterprise services environments 116 that may in turn disseminate, depending on the stage of the current release, various artifacts in the CDD box set 112A1 or the entire CDD box set 112A1 to one or more environments. For example, the enterprise services environments module 116 may disseminate the plurality of artifacts from the code repository 108 to a development environment 118 for an engineering release, to a Web environment 126 for a release to the Web, to a manufacturing environment 116 for a release to manufacturing, and/or to a production environment (not shown) for a release to production.

An engineering release to the development environment 118 enables all members collaborating on the same software application to access the up-to-date versions of various pieces of the software application without worrying about uncommitted changes or outdated versions. The development environment 118 may invoke various tests or test suites 128 to perform various tests to determine whether the current version of the software application may be released to the next stage in the software release life cycle. For example, the development environment 118 may invoke component tests to test individual software application components, integration tests to verify the interfaces between individual software application components, and/or interface tests to check handling of data between different units or subsystem components.

Once the release of the software application meets the requirements, rules, and/constraints (collectively requirement for singular or requirements for plural) of the development environment 118, the plurality of artifacts may be forwarded to a quality check environment 120. The quality check environment 120 may invoke various tests or test suites 128 to perform various tests to determine whether the current version of the software application may be released to the next stage in the software release life cycle. For example, the quality check environment 128 may invoke quality tests to verify whether the software application is operationally ready.

Once the software application satisfies the quality check requirements in the quality check environment 120, the plurality of artifacts (or the box set) may be forwarded to the system environment 122 which may further invoke one or more tests or test suites 122 to perform system testing or end-to-end testing that tests the completely integrated software application to verify whether the completely integrated software application meets various requirements. In some embodiments, once the software application satisfies the quality check requirements in the quality check environment 120, the plurality of artifacts (or the box set) may be forwarded to the performance test environment 124 to verify how the performance of the software application in its intended environment or platform performs in terms of, for example, responsiveness and/or stability under one or more workloads.

It shall be noted that although FIG. 1A does not appear to connect the Web environment 126 or the manufacturing environment 116 with the tests or test suites 128, either environment or both environments may nevertheless be operatively coupled to the tests or test suites 128 to invoke various appropriate tests to verify whether the software application meets various requirements. It shall be noted that any modules described herein may function in a fully automated fashion without human intervention other than writing the code for the software application or preparing documentation (e.g., software manuals, papers, etc.) for a software application.

FIG. 1B illustrates more details about an example code repository illustrated in the high level block diagram in FIG. 1A of a system for implementing software development and releases in one or more embodiments. More specifically, the code repository 108 may include a copy of an actual artifact to be included in a deployment of a software application release. In contrast, the deployment repository (110) may include references pointing to the copies of actual artifacts, instead of copies of these artifacts. These references may include, for example, link structures, pointers, symbolic links, etc. Some examples of such references included in the deployment repository (110) may include uniform resource locators (URLs) or uniform resource identifiers (URIs).

The code repository 108 may categorize or group artifacts into a plurality of sets or individual files. In these embodiments illustrated in FIG. 1B, the code repository 108 may, for example, categorize artifacts and store deployment artifacts 102B, one or more quality tests 104B, one or more smoke tests 106B, database scripts and/or schemas 108B, one or more properties 110B (e.g., global properties, software application configuration properties, etc.), or any other information or data desired or required to support the deployment of a release of a software application. Each category or group of artifacts may be stored as a separate set of artifacts or in a single file container. For example, the code repository may store categories or groups of artifacts in a jar file container, a war file container, a zip file container, etc.

FIG. 10 illustrates more details about an example continuous development dashboard module illustrated in the high level block diagram in FIG. 1A of a system for implementing software development and releases in one or more embodiments. More specifically, FIG. 10 illustrates more details about the invocation of a continuous deployment dashboard module 112 via one or more computing systems 150C.

In addition to collecting or presenting data (e.g., real-time data or metrics) or generating reports for various levels of reviews of the performance and/or the correctness of the artifacts, the continuous deployment dashboard 112 may receive the box set from a branch management module or a release management module as a CDD (continuous deployment dashboard) box set 102C and further forward the CDD box set 102C to one or more CDD signoff modules 104C to transmit the CDD box set 102C or data or information therefor to one or more levels in the signoff hierarchy in order to obtain approval from these one or more levels in the signoff hierarchy.

The one or more CDD signoff modules 104C may collaborate with various environments via the CDD deployment module 106C. As described in FIG. 1A, some or all of these various environments may invoke appropriate tests to verify various aspects of the software application. These test results may be sent back to the continuous deployment dashboard 112 to display various test results, benchmarks, etc. or various reports thereof.

FIG. 1D illustrates more details about an example enterprise continuous deployment module illustrated in the high level block diagram in FIG. 1A of a system for implementing software development and releases in one or more embodiments. More specifically, FIG. 1D illustrates more details about the invocation of an enterprise continuous deployment module 114 via one or more computing systems 150C. The enterprise continuous deployment module 114 receives a box set from the continuous deployment dashboard (e.g., 112) and, depending upon the stage of the release determined by the enterprise services environments module 102D, releases the box set to one or more environments.

These one or more environments into which the box set may be released may include, for example, manufacturing environment, a Web environment, a performance test environment, a quality check environment, and/or a system environment. Therefore, depending upon the stage of the release, the enterprise services environments module 102D may release the box set to the development environment at 104D, release the box set to the quality check environment at 106D, release to the system environment 108D, release the box set to the manufacturing environment at 110D, release the box set to the Web environment at 112D, and/or release the box set to the performance test environment at 114D.

One or more of these environments into which a box set is released may perform various tests or verifications by using one or more tests or test suites 116D. The one or more test or test suites 116D may include a plurality of test artifacts comprising, for example, test plans, test cases including identifiers, traceability data structures, preconditions, a set of actions to be performed, etc., scripts, test data, and/or test fixtures for various tests in some embodiments.

For example, component level software testing and integration level software testing may be performed in the development environment 104D with one or more component level tests or test suites and one or more integration level tests, respectively. An application of one or more defect prevention or defect detection procedures or scripts or a static code analysis may also be performed in the development environment 104D to reduce development risks, time, or costs or to eliminate or reduce construction errors before the software application is forwarded to the quality check environment 106D.

Software quality assurance testing may be performed in the software quality check environment 106D with one or more quality assurance tests or test suites. System level software testing or end-to-end software testing may be performed on an integrated software application in the system environment 108D with one or more system level tests or test suites to verify whether the integrated software application meets the requirements.

One or more regression, sanity tests, or smoke tests may also be performed in the system environment 108D. A smoke test includes a minimal or reduced number of attempts to operate the software application and determines whether there are basic problems that may prevent the software application from working at all. A sanity test determines whether further testing may be required or desired. A regression test identifies defects in the software application, especially after some code change, to uncover software regressions that include, for example, old bugs or unintended consequences that have come back, etc. Performance tests may be performed in the performance test environment 112D to determine how the software application or one or more sub-module thereof perform in terms of responsiveness or stability under one or more specific workloads or to validate or verify other attributes or metrics (e.g., resource utilization, reliability, or scalability, etc.) of the software application.

FIG. 1E illustrates more details about an example of the release management modules illustrated in the high level block diagram in FIG. 1A of a system for implementing software development and releases in one or more embodiments. More specifically, FIG. 1E illustrates more details about the release management module 102. In these embodiments, the release management module 102 may include or invoke various modules hosted on one or more computing systems via a computer network. These modules may include, for example, one or more release builder module 102E that respectively generate, assemble, compile, or build their respective release models or packages at 152E.

The release management module 102 may further invoke the package identifying module 104E that identifies, at 154E, software objects (e.g., artifacts 114E) with appropriate package types 112E. For example, the package identifying module 104E may identify software objects as a “war” type for all “.war” objects, a “zip” type for all “.zip” objects, a “jar” type for all “.jar” objects, etc. The package identifying module 104E may also identify software objects as various package types based on the platforms or server environments.

For example, the package identifying module 104E may identify all objects or artifacts that are related to or associated with a specific integration framework or framework (e.g., a Java-based integration framework such as Apache Mule, a Web server environment, etc.) For various tests for software testing, database scripts and schemas, etc., the package identifying module 104E may identify these artifacts or objects as a “zip” package type. For aggregating other artifacts or objects (e.g., Java class files), metadata, and/or resources (e.g., test, images, etc.) that do not belong to any of the aforementioned package types, the package identifying module 104E may identify these objects as a “jar” package type. These package types 112E may be further referenced in the generation of separate box sets for a release of a software application such that artifacts identified with the same package type will be categorized or grouped into the same set of artifacts or the same file container. Other available package types 12E may include, for example, a POM (project object model) package type, an EJB (Enterprise JavaBeans) package type, plugins 120E, an EAR (Enterprise Archive format) package type, an RAR (a compressed file format) package type, a PAR (parity recovery file format) package type, or any other suitable package types.

The release management module 102 may also invoke a resource generator module 106E that generates resources 122E that are desired or required for a release of a software application at 156E. These software resources 122E may include, for example, software needed for the software application to run in one or more computing platforms or frameworks, application programming interfaces, drivers, and/or one or more browsers and their respective plugins, extensions, etc., or any other required or desired software resources. The release management module 102 may also invoke a resource process module 108E that processes various resources 122E during the build, testing, compilation, deployment, and/or installation of the software application at 158E. The release management module 102 may also invoke a data access module 110E that provide common data access mechanisms shared by all collaborating client computing systems as well as one or more servers hosting various modules describe herein to access various pieces of data or information at 160E. The release management module 102 may also invoke a dependency module 112E that generates and tracks dependencies among related artifacts at 162E.

FIG. 1F illustrates more details about the high level block diagram in FIG. 1A of a system for implementing software development and releases and some example modules as well as their functions in one or more embodiments. More specifically, FIG. 1F illustrates more details about the branch management module 104. In these embodiments, the branch management module 104 on a computing system may include or invoke one or more modules hosted on one or more other computing systems to perform various functions as illustrated in 152F through 158F.

When a user on a client computing system 100F checks out a portion of a software application to perform, for example, various code construction or modification, the branch management module 104 may invoke the branching module 110F on behalf of the client computing system 100F to generate a project and initiate a build process for the project with a project object model at 156F. The branching module 110F may further identify an existing branch or generate a new branch off the master branch or an existing branch off the master branch of the software application at 158F. The automatic tagging module 112F in the branch management module 104 ensures that every branch is associated with a unique branch identification, and that these unique branch identifications are centrally maintained so that all client computing systems and other modules described herein reference these unique branch identifications when performing various tasks. The automatic tagging module 112F may also automatically tag an artifact with a new version or revision when the artifact is created or modified.

A user on a client computing system 100F may access the branch management module 104 to perform various tasks on one or more branches off the master branch of a software application. The client computing machine 100F may include one or more databases 104F as local databases on the client computing system. That is, these one or more databases 104F may be residing locally on the client computing system (e.g., a laptop of a developer) and may commit locally via a client branch management module (not shown) on the local client computing system 100F until the client computing system 100F has network connection or a virtual private network (VPN) to upload or merge data of committed transactions to the code repository 108F via a database system 102F and the merge module 114F.

Moreover, when a client computing system modifies an artifact, the data being modified is stored at a staging area on the client computing system. When performing a commit, the data (e.g., a snapshot) is moved from the staging area to the storage (e.g., permanently storing the data in the local storage for a local commit and the code repository for a commit to the server). In addition, once the user or the client computing system has performed various tasks on the portion of the software application under a branch, the client computing system 100F may merge the local data via the merge module 114F and update the branching data of the software application via the branching module 110F of the branch management module 104.

In other words, a local client computing system 100F in these embodiments may commit one or more transactions (e.g., modification of an existing piece of artifact) locally on the client computing system 100F when the local client computing system 100F does not have network access or may commit to the code repository 108 via the merge module 114F and the database system 102F when the local client computing 100F has network connection to the branch management module 104 and the code repository 108 on a server.

Moreover, when a client computing system 100F commits a transaction (e.g., by saving the state of portion of the software application), the snapshot module 106F in the branch management module 104 on the server (when connected to the client computing system via a network) or in the client branch management module (when not connected to the server on which the branch management module resides) residing locally on the client computing system 100F may take a snapshot of what all the artifacts on the client computing system 100F are and store a reference to this snapshot, instead of the changes, at 152F after performing a checksum or another appropriate error detection task at 154F by the data verification module 108F.

If an artifact has not changed since the last commit, this artifact is not stored again, but only a link to the previous identical artifact will be referenced in the snapshot of the committed transaction. In these embodiments, computational resource utilization is reduced because not all artifacts have to be rewritten and further because writing links to artifacts are more efficient than writing the corresponding artifacts. In addition, the commit mechanism, the checksum performed, and the snapshots ensure that the contents of a software application cannot be mutilated without going through the branch management module 104. The result is a tightly controlled versioning mechanism and branching strategy in a software release life cycle.

FIG. 1G illustrates more details about the high level block diagram in FIG. 1A of a system for implementing software development and releases and some other example modules as well as their functions in one or more embodiments. More specifically, FIG. 1G illustrates more details about a code development module 106. A code development module 106 may be communicably coupled to one or more databases (104F) and the code repository 108. A code development module 106 on a computing system may also include or invoke one or more modules 1000 that reside on one or more other computing systems.

In some embodiments, these one or more modules 100G may include a packaging identification module 102G that associates a packaging type with a box set or even an artifact using a packaging tag or identifier at 152G. Available packaging types for box sets or artifacts may include, for example, different formats or file types of packages that are to be deployed. For example, the packaging identification module 102G may identify artifacts or box sets as one or more of the “zip”, “rar”, “war”, “ejb”, “jar”, “par”, etc. packaging types. Available packaging types for box sets or artifacts may alternatively or additionally include, for example, types based on integration frameworks of the software application, or the target recipients of the deployment. For example, the packaging identification module 102G may identify artifacts or box sets with corresponding packaging types for different integration platforms (e.g., an enterprise service bus framework, a specific web server environment, etc.) or for different target recipients of the artifacts or box sets. For example, the quality check team may receive the artifacts or box sets related to various quality tests in a first packaging type; a smoke test team may receive the artifacts or box sets related to various smoke tests in a second packaging type; etc.

These one or more modules may include a project object model module 104G that generates a project and initiates a build process for the project with a project object model (POM) at 154G to perform various functions. For example, the project object model module 104G may create and update a workspace for the project and create an environment for the build process to run in. The project object model module 104G may also capture metadata or parameters about various inputs and outputs of the build process to ensure repeatability and reliability.

In addition or in the alternative, the project object model module 104G may also identify or tag various points of interest in a history of the project by using, for example, tag objects. A tag object is a container that includes a reference to another object and may hold metadata related to another object. For example, the project object model module 104G may tag an artifact that has been committed as a commit artifact with a tag object to store information such as a particular release of the commit artifact. The project object model module 104G may also perform program or code analysis to ensure the quality of artifacts produced via the one or more code development modules 106. In addition, the project object model module 104G may perform compilation or interpretation.

These one or more modules may include an information generation and retrieval module 106G that retrieves and generates project information and build information at 156G for the project generated at 154G by the project object model module 104G. Some examples of project information that may be generated or retrieved by the information generation and retrieval module 106G may include, for example, change log information, cross referenced sources, dependency lists, or any other desired or required information.

These one or more modules may include a build module 108G that performs various functions including, for example, version control, program or code analyses for checking code quality, compilation, interpretation (for interpreted languages such as Python or Perl), etc. The build module 108G may also generate build cycle information in some embodiments. These one or more modules may include one or more test modules 110G that set up corresponding test environments without relying on customizing the build process for test preparation at 158G and identify and execute corresponding tests at 160G. These one or more test modules 110G may also automatically specify or create test cases, test plans, traceability data structures for corresponding tests, preconditions, a series of actions to be performed for each test, and/or report test results in some of these embodiments. These one or more modules may include a code hierarchy module 112G that generates and maintains, at 162G, hierarchies indicating parent-child relationships for artifacts of the project created at 154G.

FIG. 1H illustrates more details about an example of test modules in a system for implementing software development and releases in one or more embodiments. More specifically, FIG. 1H illustrates more details about software testing for a software application with various tests or test suites 128 to evaluate various aspects of the software application. Software testing with the tests or test suites 128 may thus include exercising the execution control, instruction simulations, and/or step-by-step execution and breakpoints insertion, etc. for the software application at 132H, performing benchmarks to determine runtime performance comparisons at 134H, and performing performance analyses at 136H to identify hot spots and resource utilization of the software application.

Software testing under these techniques described herein may invoke one or more modules 100H that may include, for example, a competent testing module 102H that performs unit testing for one or more individual components in the software application under test.

According to the techniques described herein, software testing may also include invoking an integration testing module 104H that verifies the interfaces and interactions between individual software application components. Moreover, these techniques described herein may provide the capabilities of integrating individual software application components interactively or automatically in a flat or hierarchical manner to expose bugs or defects in the interfaces or interactions among individual software application components according to the architecture of the software application.

In addition or in the alternative, a system testing module 106H may be invoked to perform system testing that tests an integrated software application to determine whether the integrated software application meets various requirements for the software application. Also, a development testing module 108H may be invoked to apply various procedures to detect, reduce, or eliminate defects or to reduce or eliminate construction errors in the software application during the development stage in, for example, the development environment. The development testing module 108H is often invoked prior to the invocation of the quality testing module 116H that verifies the software application and the software engineering process to detect and reduce the number of defects or faults to a level below the acceptable software fault threshold. In some embodiments, the quality testing module 116H compares the expected results of a software application with the actual test results generated by one or more sets of inputs.

A smoke testing module 110H may also be invoked to perform one or more smoke tests that respective include a minimal or reduced set of tasks to operate a software application in order to determine whether the software application exhibits any issues preventing the software application from functioning or whether the software application may undergo further testing. In addition or in the alternative, a regression testing module 112H may be invoked to discover unintended software behaviors or regressions such as degradations, fixed yet recurring bugs, missing features, etc. The software testing with the techniques described herein may also invoke performance testing module 114H that determines how the software application or any portion thereof performs in terms of responsiveness, stability, reliability, scalability, computational resource utilization, etc. under one or more workloads. A compatibility testing module 116H may also be invoked to check the compatibility among different individual components or different modules of a software application as well as the compatibility between the software application and the operating systems, one or more other software application, etc. Each of these tests may be deployed to a different recipient. For example, quality tests may be deployed to the quality testing team; and development tests may be deployed to the development team; etc.

In developing, bundling, and deploying these tests, these techniques may identify a set of requirements, rules, or constraints (collectively requirements) at 152H for a software application. As described earlier, these techniques track artifacts, packages, and box sets as they are being created or modified. These techniques may thus optionally identify changes, if any, made to a software application or a portion thereof since the last release or commit at 154H. These techniques may further automatically determine one or more test strategies, one or more test plans, etc. at 156H for one or more upcoming tests on the software application. In some embodiments, these one or more test strategies, one or more test plans, etc. may be developed automatically without any human intervention by using, for example, artificial intelligence techniques (e.g., neural networks, machine learning, etc.) or heuristics.

In some other embodiments, these one or more test strategies, one or more test plans, etc. may be interactively developed by, for example, presenting a test developer with a set of questionnaires or a set of interview questions and formulating these one or more test strategies, one or more test plans, etc. according to the responses of the test developer. These techniques described herein may also develop test cases, test procedures, test scenarios, etc. at 158H either automatically or interactively as described above for the development of the one or more test strategies, one or more test plans, etc. In addition, these techniques may execute one or more pertinent sets of tests at 160H for various purposes as described above. The results of these one or more tests may be benchmarked or analyzed at 162H and presented for review, and these techniques may further automatically fix bugs with or within human intervention and close these one or more tests at 164H.

FIG. 1I illustrates a high level system diagram of a system that implements software development and releases in some embodiments. More specifically, FIG. 1I illustrates a computing platform including a plurality of computing systems (2) such as desktops, laptops, work stations, terminals, servers, etc. The plurality of computing systems (2) are communicatively connected to one another via the network (4). The plurality of computing systems may each perform read and/or write access to a set of data or information (6) that may further include, for example, a plurality of deployable artifacts (8), a plurality of non-deployable artifacts (10), a plurality of libraries (12), a plurality of procedures (14), or any other desired or required data or information. The set of data or information (6) may further include a plurality of snapshots (16) and a plurality of database tables (18) as well as their schemas and scripts.

The set of data or information (6) may be entirely installed on a computing system or may be entirely hosted on the one or more servers while the other computing systems utilize the network 6 to access the set of data or information (6). The plurality of computing systems (2) may be communicatively connected to application software or software services (e.g., software as a service or SaaS) (20) that may further include, for example but not limited to, a tax return preparation application software or software service (22), an accounting application software or software service (24), a finance application software or software service (26), an enterprise application software (28), etc.

An application software or software service described herein includes a computer program that is configured or designed to perform specific tasks (e.g., word processing, accounting, financial management, tax return preparation, etc.) beyond the basic or general operations of computers in some embodiments. An application software or software service may be modularized or non-modularized and is distinguishable from operating systems, utilities, or software systems such as search engines. A utility is a program designed to perform a particular function for compute system management and is not an application software or software service. An operating system is system software that manages hardware and software resources of a computer and provides common services for computer programs and is not an application software or software service. These application software or software services may constitute the targets for the application of various techniques described herein.

The plurality of computing systems (2) may access a code repository (32) and a deployment repository (34) through network (30) that may be identical to or different from the network (4) described above. In addition, the plurality of computing systems (2) may further access a set of modules that may execute in a parallel computing paradigm or a distributed computing paradigm to perform respective functions provided by the set of modules (36).

For example, the set of modules may include a branch management module (38) that provides branching functionalities, a release management module (40) that manages releases of software applications, and a snapshot module (42) that creates a snapshot when a transaction involving one or more artifacts of a software application commits. In addition, the set of modules (36) may also include a deployment module (44) that deploys artifacts or box sets of artifacts to corresponding recipients or modules, one or more box set generation modules (46) that generate one or more box sets for deployment, and a deployable artifact generation module (48) that automatically or interactively generate artifacts that are to be bundled for deployment to their respective recipients or modules.

The set of modules (36) may also include one or more signoff modules (52) that provide various pieces of information, results, or benchmarks, etc. to various levels of approval authorities for review and approval. A non-deployable artifact generation module (50) may also be included in the set of modules (36) to automatically or interactively generate artifacts that are not bundled with packages or box sets to be deployed to their respective recipients or modules. In addition, the set of modules (36) may include one or more test modules (54) to specify, develop, generate, execute, and analyze tests on a software application.

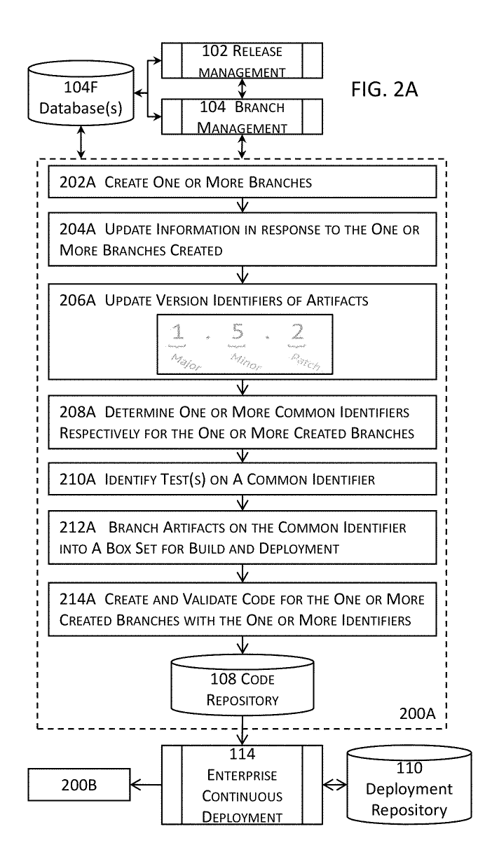

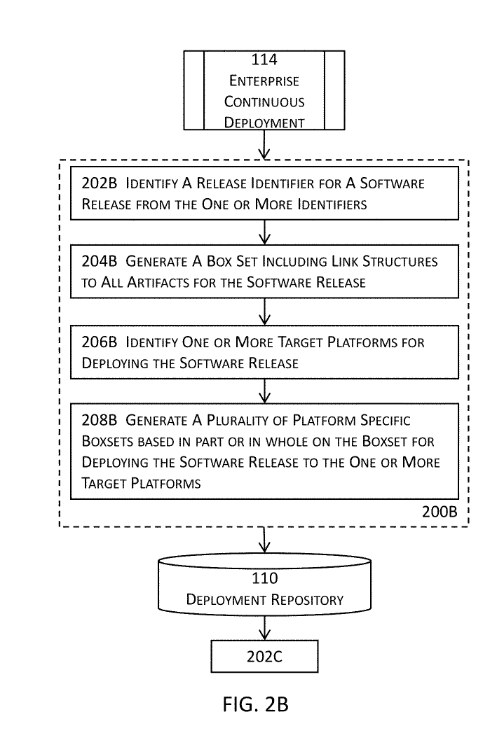

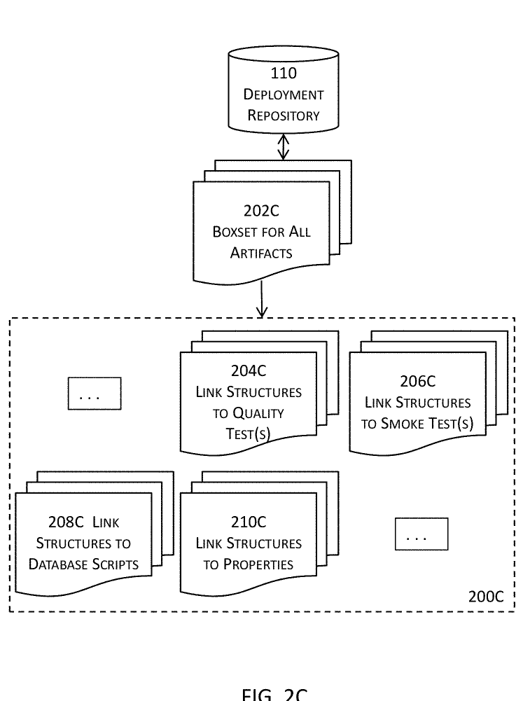

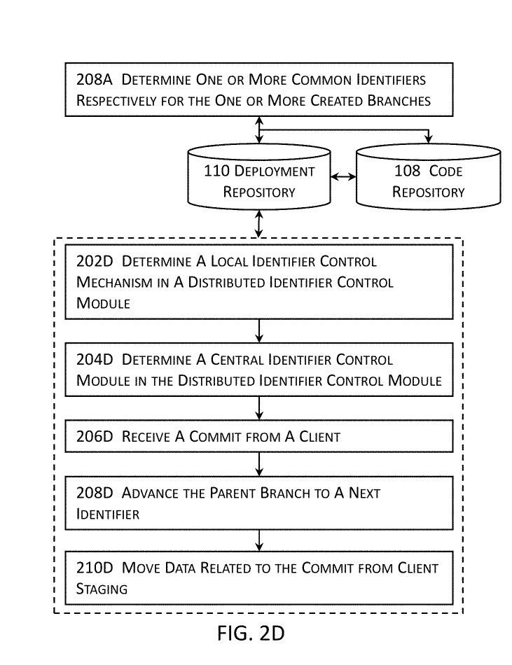

FIG. 2A illustrates a high level block diagram of a branch management module in a system for implementing software development and releases in one or more embodiments. In these embodiments, the branch management module 104 may collaborate with the release management module 102 and one or more databases 104F to perform various functionalities described herein. The branch management module 104 illustrates in FIG. 2A may include a client branch management module 104 that communicates with the branch management module on a server.

Similarly, the release management module 102 may include a client release management module 102 residing on a client computing system and communicably coupled to a release management module on a server. These one or more databases 104F may include one or more local databases or database tables residing on a client computing system to store locally committed transactions such as transactions creating new artifacts or transactions modifying existing artifacts while the client system is not connected to the release management module or the branch management module on one or more servers.

Once the client computing system returns online, these committed local transaction data may be merged or uploaded to the server, and the records for the release management module and the branch management module may be updated as well. In this manner, any user may work on the respective tasks for the deployment of a release of a software application at any time regardless of whether the client computing system is connected to one or more servers managing various aspects of the deployment. The branch management module 104 may create one or more branches off an existing branch at 202A for a software application. In response to the one or more created branches, the information about the one or more branches or the parent branch (e.g., a master branch, a feature branch, a release branch, etc.) off which these one or more branches are created may be updated to reflect the fact that this parent branch now includes these one or more created branches as one or more child branches.

The branch management module 104 may also track and manage artifacts and their corresponding version identifiers at 206A by using, for example, a major release version identifier, a minor release version identifier, a patch version identifier, etc. where at least one of the major release version identifier or the minor release version identifier are centrally managed and maintained by a central server on which the server branch management module is located so that any users need to contact the central server to create or alter such identifiers. One or more common identifiers respectively for the one or more created branches at 208A.

In some embodiments, these one or more common identifiers may be created based at least in part upon the latest commit or the latest common identifier of the parent branch from which these one or more branches are created. In this manner, any users may create new branches with distinguishing common identifiers for the tasks these users are working on while the artifacts generated or modified within these branches may successfully be merged back to the parent branch without conflicting or confusing with the artifacts produced or modified in other branches or the parent branch.

One or more tests may be identified with a common identifier or packaging type at 210A. More details about identifying artifacts with identifiers or packaging types are described above with reference to FIGS. 1G and 1H and thus will not be repeated. Artifacts on a common identifier may be branched into a box set at 212A for subsequent software build or deployment. More specifically, an artifact and its version identifier are tracked and updated when there is a change to the artifact. For example, when a user commits or saves the state of the branch the user is on, the branch management module 104 may take a snapshot of the artifacts and store a reference to this snapshot regardless of whether or not the computing system is connected to the server on which the server branch management module is located.

If a first artifact has not been changed since the last commit, this snapshot merely stores a reference to the previous version of the first artifact. If a second artifact is modified or created, this snapshot stores a relative reference to the newly created or modified second artifact having a different identifier than the previous version from the last commit, and both the snapshot as well as the newly created or modified second artifact will be merged with the records on the server once the computing system returns online. This snapshot may be generated by performing a query on the one or more databases 104F to return a query result set including information (e.g., references) about the artifacts associated with a specific commit within a particular branch.

An artifact may also be identified with another identifier (e.g., a packaging type) that may be further referenced in the creation of box sets or in the determination of its target deployment recipient. Therefore, different artifacts corresponding to the same packaging type may be branched accordingly at 212A to automatically collect these artifacts and to automatically generate the required or desired box sets for deployment. The code or any other related artifacts may be created and validated for these one or more created branches at 214A with the one or more common identifiers determined at 208A by using, for example a development testing module (108H). For example, checksum, error detection, or any other suitable techniques may be performed at 214A to validate the code or any other artifacts before the code or the artifacts are committed or stored permanently to prevent, for example, construction errors in the artifacts.

Once the artifacts are validated, and the client computing system is connected with the server hosting the server branch management module and the server release management module, the newly created or modified artifacts may be merged into the code repository 108, and the created box sets may be merged into the deployment repository (110). The snapshots created on the client computing system may also be merged into a snapshot database while the relative references to the artifacts may be replaced with appropriate references according to the architecture or schema of the data storage. As described above, the code repository 108 stores the actual copies of various artifacts, while the deployment repository (110) stores the references to these actual copies of artifacts. The code repository 108 is further communicably coupled with the enterprise continuous deployment module 114 that in turn communicates with the deployment repository 110 and may perform various actions for various functionalities as illustrated in 200B of FIG. 2B.

FIG. 2B illustrates a high level block diagram of the enterprise continuous deployment module in a system for implementing software development and releases in one or more embodiments. More specifically, FIG. 2B illustrates some examples of the functions of the enterprise continuous deployment module 114. In these embodiments, a release identifier may be identified from one or more release identifiers at 202B for a deployment for a release of a software application.

The release identifier may include or correspond to, for example, a major release version identifier, a minor release version identifier, or a patch release version identifier for the software application or for one or more artifacts therefor. In some embodiments, release identifiers are centrally created, controlled, and managed by the release management module residing on a server computer to ensure that all collaboration units work off the same release version. In some of these embodiments, the release identifier identified at 202B may also be based in part or in whole upon version identifiers of artifacts and/or packaging types that may be created either via a server computer on behalf of one or more online client computing systems or at these one or more client computing systems when these one or more client computing systems are offline and not connected to the server computer.

A box set including link structures to all artifacts to be bundled with the release may be generated at 204B. These link structures may include, for example, links, indices, pointers, symbolic links, addresses, handles, etc. For example, a box set may include uniform resource locators or uniform resource identifiers, instead of the actual copies of these artifacts, pointing to the various artifacts that are to be included for a release of a software application in some embodiments.

In these embodiments, the box set generated at 204B includes the link structures to all artifacts but not the actual copies of any of the artifacts. The generated box set may be stored in the deployment repository 110, while the actual copies of the artifacts referenced by the link structures are stored in the code repository 108 in these embodiments. In these embodiments, deploying a box sets of link structures not only consumes much less computational resources (e.g., network bandwidth) but also renders versioning control much easier because the receiving module of a box set may follow the link structures to retrieve the correct versions of artifacts that may be stored with more flexibility than packaging these artifacts in a box set for deployment. In addition, storing link structures in a box set also renders modifications to the box set much easier and utilization of computational resources much less. For example, if an artifact is updated to a new version, only the link to the new version of this artifact in the box set needs to be modified without removing the old version artifact from the box set and adding the new version into the box set.

In some other embodiments, a box set may include actual copies but not any link structures of the artifacts. The entire box set may be stored in the deployment repository 110 in these embodiments. Yet in some other embodiments, a box set may include a combination of one or more link structures to one or more first artifacts and one or more actual copies of one or more second artifacts. The portion of the generated box set including link structures as well as artifacts included in the box set may be stored in the deployment repository 110, while the actual copies of the artifacts referenced by the link structures in the portion are stored in the code repository 108 in these embodiments.

One or more target platforms or environments for the deployment of the release of the software application may be identified at 206B. For example, a Java-based integration framework, a Web server environment, a development environment, a quality check environment, a manufacturing environment, and/or one or more testing environments may be identified at 206B. These one or more target platforms or environments may be referenced in generating platform- or environment-specific box sets from the box set generated at 204B.

At 208B, a plurality of platform- or environment-specific box sets may be generated from the box set generated at 204B including the link structures to all artifacts based in part or in whole upon the one or more target platforms or environments identified at 206B. For example, the enterprise continuous deployment module 114 may generate a regression test box set for the regression testing environment, a smoke testing box set for the smoke testing environment, a quality check box set for the quality check environment, etc. The plurality of box sets generated at 208B may be stored in the deployment repository 110. More details about the box set of all artifacts and the plurality of box sets generated from the box set of all artifacts are provided below with reference to 202C of FIG. 2C.

FIG. 2C illustrates more details about the deployment repository in a system for implementing software development and releases in one or more embodiments. A first box set of all artifacts may be generated at 202C by the enterprise continuous deployment module 114, the branch management module 104, or the release management module 102. This first box set 202C including link structures to all the artifacts to be bundled for a release may be stored in the deployment repository 110. With the identified target platforms or environments, a plurality of platform- or environment-specific box sets 200C may be automatically generated from the first box set without human intervention or interactively with feedback or responses from a user in response to, for example, a set of questionnaires or interview questions.

For example, a quality test box set 204C, a smoke test box set 206C, a database script or schema box set 208C, and/or a property box set 210C, etc. may be generated from the first box set 202C. In some embodiments, each of these box sets in 200C includes link structures to corresponding artifacts, instead of the actual copies of these corresponding artifacts. In some other embodiments, a box set (e.g., 202C, 204C, 206C, 208C, or 210C) may include actual copies of the artifacts. Yet in some other embodiments, a box set may include a combination of one or more link structures to one or more first artifacts and one or more actual copies of one or more second artifacts.

FIG. 2D illustrates more details about a process for determining common identifiers for branches and its interactions with various repositories in a system for implementing software development and releases in one or more embodiments. More specifically, FIG. 2D illustrates more details about the act of determining one or more common identifiers (208A) for a branch management module illustrated in FIG. 2A in some embodiments. A common identifier includes an identification of an artifact, a package, or a release that is visible to all collaborators working on a release of a software application.

In these embodiments, a local identifier control module may be determined at 202D that may include a database maintaining a change in an artifact to a file following a commit. This local identifier control module may be residing on a client computing system. In some embodiments, the local identifier control module may also maintain a separate record including the differences between two artifacts following a commit, and this separate record may be used to reproduce the subsequent version of the artifact from the earlier version of the same artifact.

To handle collaboration among multiple members, a central identifier control module, which may be subject to the management and control of the server branch management module and reside on a server, may be determined at 204D. This central identifier control module and the local identifier control module may jointly form a distributed identifier control module. This central identifier control module may include one or more databases that store thereupon all the deployable and non-deployable artifacts of all versions.

Upon the creation of a branch that includes a reference to a commit, a newly created artifact under the branch may be stored as a separate object or file with a unique identifier in some embodiments. In some other embodiments, a plurality of newly created artifacts may be stored in a single object or file that may be compressed in some of these embodiments. When an artifact is updated on a client computing system on a child branch, a new version of the artifact is created, and the updated artifact having the new version is stored as a new object. The identifier of this artifact may also be updated by the local identifier control module to reflect the modification to the artifact. In addition, a hierarchical structure including all the identifiers of and relationships among the artifacts for the branch may also be created when a branch is created, and the hierarchical structure may be further updated when one or more artifacts are modified to one or more newer versions.

All collaborating client computing systems may mirror but not check out the artifacts from the central identifier control module. Allowing client computing systems to mirror but not check out artifacts or even the entire repository provides a failover mechanism so that a client computing system having the entire repository may be used to rebuild the repository on the server in the event of a server failure. When a client computing system issues a commit command to the server at 206D, the data are moved at 210D from the staging area on the client computing system to a persistent repository on the server.

More specifically, the persistent repository on the server now includes the newly created artifacts, the modified artifacts, the commit object, and a hierarchical data structure specifying which identifiers of the artifacts are stored as which objects. In this manner, the newly created and modified artifacts as well as their respective identifiers from the local identifier control module will be merged back to the server. The central identifier control module or the branch management module on the server may move the master branch forward at 208D to point to this commit. In this manner, every commit from a client system is captured on the server and is therefore visible to all collaborators.

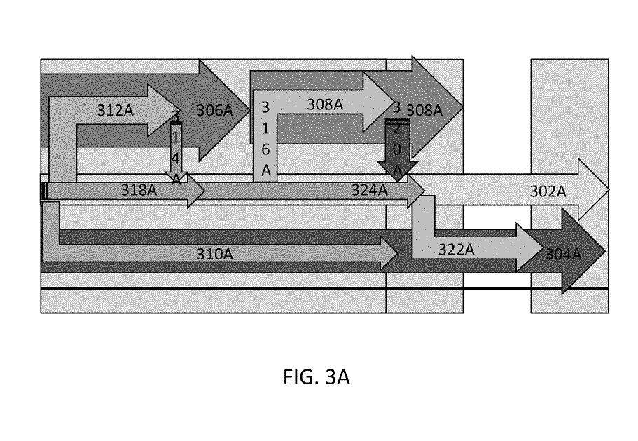

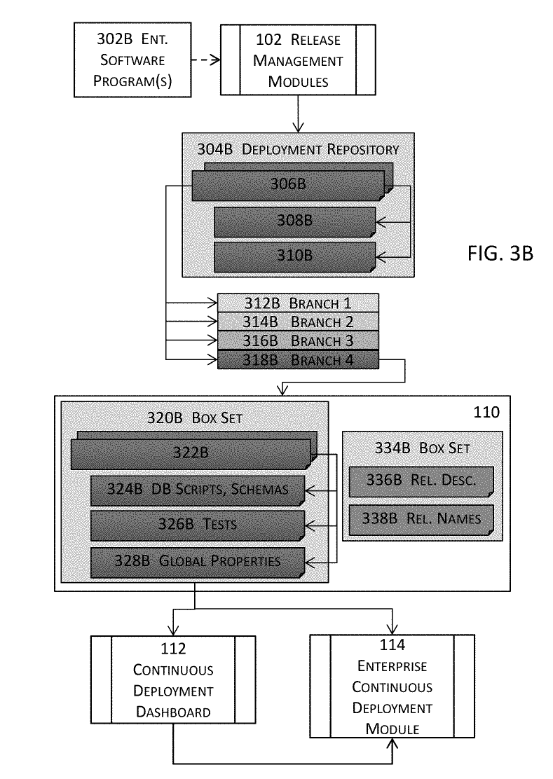

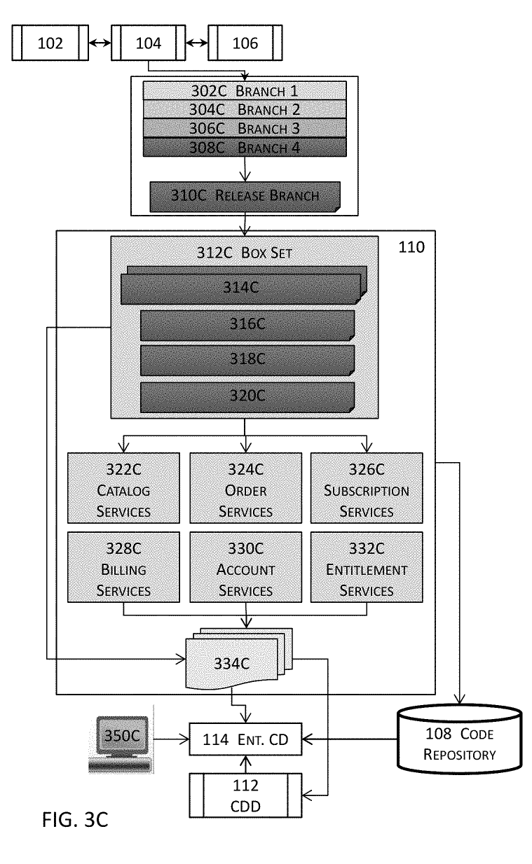

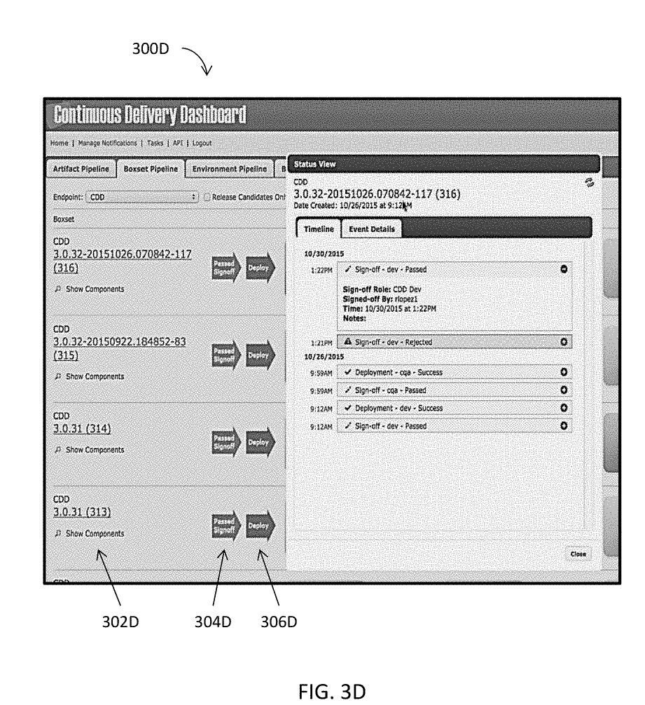

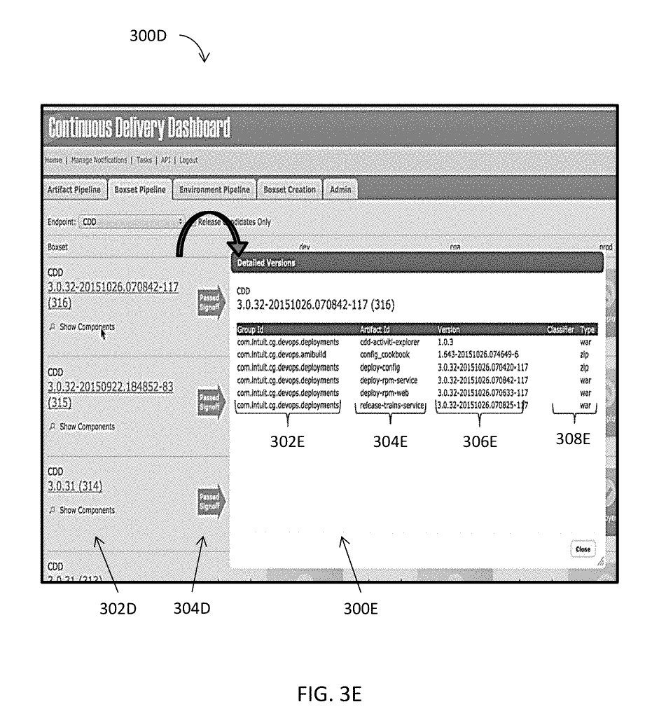

FIG. 3A illustrates a graphical example of the branch management module in a system for implementing software development and releases in one or more embodiments. In this example, a team of collaborators on a plurality of client computing systems is working on a release of a software application. In FIG. 3A, the branch management module on a server may create a master branch 302A for this software application. The master branch 302A may be associated with a pointer pointing to a common identifier (e.g., a common version identifier visible to the team) of a release.

304A graphically represents the creation of release branches off the master branch 32A; 306A graphically represents the creation of development branches off the master branch 302A, and 308A represents the creation of feature branches off the master branch 302A. For each branch created off the master branch, all artifacts may be stored in a single directory, a single object (e.g., a binary large object), or a plurality of objects (e.g., a plurality of binary large objects). 310A corresponds to a pointer pointing to a specific version identifier of a release. This pointer 310A may be advanced every time when a commit command is received from, for example, a client computing system.

When the development team attempts to modify the artifacts of the software application, the branch management module creates a new development branch 312A off the master branch 302A. A client computing system on the development team may create one or more first new artifacts or modify one or more first existing artifacts with or with human intervention, and the local identifier control module on the client computing system may associate respective new identifiers with these one or more first new artifacts or one or more first existing artifacts that have been modified. When the server receives a commit from the client computing system, the newly created and modified first artifacts, the commit object, and the corresponding hierarchical structure may be moved at 314A from the staging area in the client computing system to a persistent repository (e.g., a code repository) on the server. This commit may move the pointer of the master branch 302A to point to a new release identifier as graphically represented by 318A.

When another team attempts to modify the artifacts of the software application, the branch management module creates a new feature branch 308A off the master branch 302A in order to, for example, fix one or more bugs. A client computing system on the team may mirror the artifacts at 316A from the persistent repository and create one or more second new artifacts or modify one or more second existing artifacts with or with human intervention. The local identifier control module on the client computing system may also associate respective new identifiers with these one or more second new artifacts or one or more second existing artifacts that have been modified. When the server receives a commit from the client computing system, the newly created and modified second artifacts, the commit object, and the corresponding hierarchical structure may be moved at 320A from the staging area in the client computing system to the persistent repository (e.g., a code repository) on the server to complete the bug fix. This commit may move the pointer of the master branch 302A to point to a new release identifier as graphically represented by 324A.

The software application may be suitable for release, and the branch management module on the server may then create a release branch 322A that also mirrors the artifacts of the latest versions known by the server (e.g., there may be uncommitted changes in one or more child branches off the master branch 302A). These artifacts may be arranged into one or more box sets for deployment of the software application.

FIG. 3B illustrates an example of the operations of a release management module in a system for implementing software development and releases in one or more embodiments. In these embodiments, the release management module 102 may be coupled with the deployment repository 304B that stores thereupon one or more box sets 306B that correspond to a plurality of branches (e.g., branch 1 (312B), branch 2 (314B), branch 3 (316B), and branch 4 (318B)). The one or more box sets 306B may also include deployable artifacts 308B and non-deployable artifacts 310B that correspond to the plurality of branches. In this example, the artifacts corresponding to branch 4 (318B) may be selected for a release for one or more enterprise software programs 302B.

Because artifacts corresponding to a branch may be stored in a separate directory or a single file in some embodiments, deployable artifacts corresponding to branch 4 (318B) may be organized into a box set 320B that may be stored in a deployment repository 110. This deployable box set 320B may include a first box set 322B including all deployable artifacts 322B. A plurality of additional box sets may be created from this deployable box set 322B. For example, a first deployable box set 322B may be created from the box set 324B to include all database scripts, database schemas, etc. One or more second deployable box sets 326B may be created from the box set 322B to include the tests for the software application. A third deployable box set 328B may be created from the box set 322B to include all properties such as global properties, application configuration parameters, etc. Non-deployable artifacts may also be optionally organized into another box set 334B that may include a first non-deployable box set for release description 336B and a second non-deployable box set 338B for release names. The created box set 322B or the plurality of box sets 324B, 326B, and 328B may then be forwarded to the continuous deployment dashboard 112 and the enterprise continuous deployment module 114 to perform their respective functions as described above.

FIG. 3C illustrates an example of the operations of a branch management module in a system for implementing software development and releases in one or more embodiments. One or more code development modules 106 may work closely with the release management module 102 and the branch management module 104 to implement software development and releases. More specifically, a plurality of branches 302C, 304C, 306C, 308C, and 310C are created by the branch management module 104 as described above. Among these branches, branch 310C is selected for release.

The artifacts associated with branch 310C may be organized into a first box set 312C that include link structures to all artifacts that are to be bundled for deployment. A plurality of box sets 316C (e.g., all ZIP artifacts), 318C (e.g., all WAR artifacts), and 320C (e.g., all EAR artifacts) may be generated from the first box set 314C. The plurality of box sets may target various sub-modules of the software application such as catalog services 322C, order services 324C, subscription services 326C, billing services 348C, account services 330C, or entitlement services 332C, etc.

In some embodiments, a different plurality of box sets 334C may be generated from the first box set 314C, and these different box sets 334C may include a separate box set for each of database scripts and schemas, public application programming interfaces (API's), private API's, quality tests, regression tests, smoke tests, performance tests, etc. The plurality of box sets (316C, 318C, 320C) or the different plurality of box sets 334C may be forward to the enterprise continuous deployment module 114 that is further coupled to the continuous deployment dashboard 112 and an administrator computing system 350C. The enterprise continuous deployment module 114 may follow the link structures in each of the deployed box sets to retrieve the corresponding artifacts from the code repository 108.

FIG. 3D illustrates an example of a sign-off user interface for a CTO continuous deployment dashboard in a system for implementing software development and releases in one or more embodiments. The CTO (Chief Technology Officer) continuous deployment dashboard 300D provides a list of CDD (continuous deployment dashboard) box sets 302D that may be separately reviewed and approved as indicated by the arrowheads 304D. The CTO continuous deployment dashboard 300D also provides the means 306D to separately deploy a box set in 302D. In addition, the CTO continuous deployment dashboard 300D may also allow a user to identify a particular CDD box set and to review information about the selected CDD box set. The information may include the approval status, the time and date information of one or more deployments, whether the selected box set passed signoff as well as the authority providing signing off the selected box set, or any other desired or required information about the selected box set.

FIG. 3E illustrates an example of a CTO continuous deployment dashboard box set in a system for implementing software development and releases in one or more embodiments. In this example, the CTO continuous deployment dashboard 300D also provides a display are for additional information for the contents of a selected CDD box set. This additional information may include, for example, artifact group identifier 302E, artifact identifiers 304E, artifact version identifier 308E, artifact packaging type 310E, or any other required or desired information.

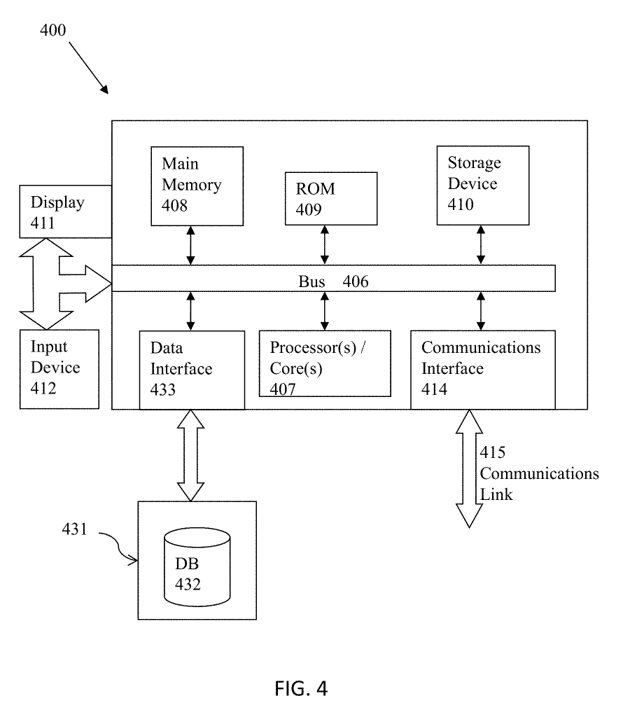

Referring to FIG. 4, a block diagram of components of an illustrative computing system 400 suitable for implementing various embodiments of the invention is illustrated. For example, the exemplary computing system 400 may be used to implement various processes as described in the preceding paragraphs and the figures such as various processes or modules of determining whether the first post is of interest, various analysis processes or modules, various other determining processes or modules, various processes or modules for performing various actions, etc. as described in the remainder of the Application. Computer system 400 includes a bus 406 or other communication mechanism for communicating information, which interconnects subsystems and devices, such as processor 407, system memory 408 (e.g., RAM), static storage device 909 (e.g., ROM), disk drive 410 (e.g., magnetic or optical), communication interface 414 (e.g., modem or Ethernet card), display 411 (e.g., CRT or LCD), input device 412 (e.g., keyboard), and cursor control (not shown).

According to one embodiment of the invention, computer system 400 performs specific operations by one or more processors or processor cores 407 executing one or more sequences of one or more instructions contained in system memory 408. Such instructions may be read into system memory 408 from another computer readable/usable storage medium, such as static storage device 409 or disk drive 410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention. In the single embodiment or in some embodiments, the one or more processors or processor cores 407 may be used to perform various actions such as various actions, processes, or modules involving determining, analyzing, performing actions, etc. In some embodiments, at least one of the one or more processors or processor cores 407 has the multithreading capability.

In one embodiment, the term “logic” shall mean any combination of software or hardware that is used to implement all or part of the invention. In the single embodiment or in some embodiments, the one or more processors or processor cores 407 may be used to perform various acts such as various acts involving determining, analyzing, performing actions, etc. In some embodiments, at least one of the one or more processors or processor cores 407 has the multithreading capability to execute a plurality of threads to perform various tasks as described in the preceding sections.

Various actions as described in the preceding paragraphs may be performed by using one or more processors, one or more processor cores, or combination thereof 407. For example, various processes or modules involving the determining action, various analysis processes or modules, etc. may be performed by one or more processors, one or more processor cores, or combination thereof.

The term “computer readable storage medium” or “computer usable storage medium” as used herein refers to any non-transitory medium that participates in providing instructions to processor 407 for execution. Such a medium may take many forms, including but not limited to, non-volatile media and volatile media. Non-volatile media includes, for example, optical or magnetic disks, such as disk drive 410. Volatile media includes dynamic memory, such as system memory 408.

Common forms of computer readable storage media includes, for example, electromechanical disk drives (such as a floppy disk, a flexible disk, or a hard disk), a flash-based, RAM-based (such as SRAM, DRAM, SDRAM, DDR, MRAM, etc.), or any other solid-state drives (SSD), a magnetic tape, any other magnetic or a magneto-optical medium, CD-ROM, any other optical medium, punch cards, paper tape, any other physical medium with patterns of holes, RAM, PROM, EPROM, FLASH-EPROM, any other memory chip or cartridge, or any other medium from which a computer can read. For example, the various forms of computer readable storage media may be used by the methods or the systems to store either temporarily or permanently information or data such as the one or more master regions, one or more master output layers, one or more global scratch layers, various transforms and inverse transforms, shapes, etc.

In an embodiment of the invention, execution of the sequences of instructions to practice the invention is performed by a single computer system 900. According to other embodiments of the invention, two or more computer systems 400 coupled by communication link 415 (e.g., LAN, PTSN, or wireless network) may perform the sequence of instructions required to practice the invention in coordination with one another.

Computer system 400 may transmit and receive messages, data, and instructions, including program, i.e., application code, through communication link 415 and communication interface 414. Received program code may be executed by processor 407 as it is received, and/or stored in disk drive 410, or other non-volatile storage for later execution. In an embodiment, the computer system 400 operates in conjunction with a data storage system 431, e.g., a data storage system 431 that contains a database 432 that is readily accessible by the computer system 400. The computer system 400 communicates with the data storage system 431 through a data interface 433. A data interface 933, which is coupled to the bus 406, transmits and receives electrical, electromagnetic or optical signals that include data streams representing various types of signal information, e.g., instructions, messages and data. In embodiments of the invention, the functions of the data interface 433 may be performed by the communication interface 414.

In the foregoing specification, embodiments have been described with reference to the figures. It will, however, be evident that various modifications and changes may be made thereto without departing from the broader spirit and scope of the invention, and that figures and examples provided are not provided to limit the scope of embodiments. Thus, the specification and drawings are, accordingly, to be regarded in an illustrative rather than restrictive sense.

It shall also be noted that although various examples described or drawings illustrated herein refer to a merchant's pairing a connected device (e.g., a cellular phone) with a wireless peripheral (e.g., a wireless transaction card reader), various aspects described apply with full and equal effects to any users who are pairing their connected devices to various types of wireless peripherals. Therefore, the reference to a merchant or a wireless transaction card reader are not intended to and shall not be interpreted as limiting the scope of the application or the scope of the claims, unless otherwise specifically recited or claimed.

Further, where methods or processes described above indicate certain events occurring in certain order, those of ordinary skill in the art having the benefit of this disclosure would recognize that the ordering may be modified and that such modifications are in accordance with the variations of the invention. Additionally, parts of methods may be performed concurrently in a parallel process when possible, as well as performed sequentially. Accordingly, embodiments are intended to exemplify alternatives, modifications, and equivalents that may fall within the scope of the claims.

What is claimed is:

1. A system for implementing software development and releases, comprising:
one or more server computers connected to a plurality of client computing systems via one or more computer networks;
a branch management module operatively coupled to the release management module and configured at least to automatically create one or more branches for deployment of a software application release;
at least one persistent deployment repository accessible by at least the branch management module and the release management module and configured to store link structures corresponding to a plurality of artifacts for the software application release; and
at least one persistent code repository accessible by at least the branch management module and the release management module and configured to store the plurality of artifacts.

2. The system of claim 1, further comprising:
a release management module hosted on at least one server computer of the one or more server computers.

3. The system of claim 2, wherein the branch management module is further configured to generate a first box set and to identify link structures corresponding to the plurality of artifacts for the software application release.

4. The system of claim 3, wherein the branch management module is further configured to generate a plurality of box sets from the first box set and to identify respective link structures corresponding to artifacts in each of the plurality of box sets based in part or in whole upon one or more integration platforms or environments for the deployment of the software application release.

5. The system of claim 4, further comprising:
a continuous deployment dashboard module configured to receive the plurality of box sets from the at least one deployment repository; and
an enterprise continuous deployment module operatively coupled with the at least one persistent code repository and configured to receive the plurality of box sets based in part or in whole upon one or more acts performed by the continuous deployment dashboard module.

6. The system of claim 5, wherein the enterprise continuous deployment module is further configured to deploy the plurality of box sets to one or more enterprise services environments comprising at least one of a development environment, a quality check environment, a system environment, a Web environment, a manufacturing environment, or a performance test environment.

7. The system of claim 1, the release management module comprising at least one of:
a release builder module that is configured to generate one or more models or packages for the software application release;
a package identifying module that is configured to identify the plurality of artifacts with their respective packaging types;
a resource generator module that is configured to generate software resources for the software application release;
a software resource processing module that is configured to process at least some of the software resources;
a data access module that is configured to provide one or more common data access mechanisms to access data or information related to the software application release; or
a dependency module that is configured to generate and track dependencies among at least some of the plurality of artifacts.

8. The system of claim 1, the branch management module comprising at least one of:
a snapshot module that is configured to take one or more snapshots of a state of a branch for the software application release upon an invocation of a commit command received from one or more modules operating on the branch;
a data verification module that is configured to verify at least a newly created artifact or a modified artifact in the plurality of artifacts upon an invocation of the commit command received from the one or more modules operating on the branch and before storing the newly created artifact or the modified artifact in the at least one persistent code repository;
a branching module that is configured to generate a project for the software application release, to create a branch with a common branch identifier, and to initiate a build process for the project with a project object model;
a merge module that is configured to merge the newly created artifact or the modified artifact back into the one or more server computers; or
an automatic tagging module that is configured to automatically tag at least some artifacts of the plurality artifacts with respective identifiers or package types.

9. The system of claim 1, further comprising:
one or more code development modules that are configured to reside on or to interact with the plurality of client computing systems and are operatively coupled with at least the branch management module.

10. The system of claim 9, a code development module of the one or more code development modules comprising at least one of:
a packaging identification module that is configured to associate a packaging type with the box set or a newly created artifact of the plurality of artifacts;
a project object model module that is configured to generate a project and initiate a build process for the project with a project object model;
an information generation and retrieval module that is configured to generate or retrieve object information and build information for the project object model;
a build module that is configured to generate a build process and to perform version control, one or more code or program analyses, compilation, or interpretation for at least some artifacts of the plurality of artifacts for the build process;
one or more test modules that are configured to automatically generate one or more tests and to set up one or more testing environments without relying on customizing the build process for the one or more tests; or
a code hierarchy module that is configured to generate and maintain hierarchies indicating parent-child relationships among at least some artifacts of the plurality of artifacts.

11. A computer implemented method for implementing software development and releases, comprising:
one or more server computers connected to a plurality of client computing devices via one or more computer networks and comprising at least a branch management module and a release management module that are stored at least partially in memory of the one or more server computers, the one or more server performing a process, and the processing comprising:
initiating a software application release for a software application at least by creating a branch, at the branch management module, for the software application release;
automatically identifying a plurality of artifacts for the software application release based in part or in whole upon a plurality of packaging types associated with the plurality of artifacts;
automatically packaging the plurality of artifacts into one or more box sets for deployment into one or more corresponding environments for the software application release; and
deploying the one or more box sets into the one or more corresponding environments to complete the software application release.

12. The machine implemented method of claim 11, the act of initiating a software application release comprising:
identifying the branch with a common branch identifier visible to the plurality of client computing systems;
generating a project for the software application release;
initiating a build process for the project by using a project object model;
generating a snapshot by performing a database query in response to a commit command to store a state of at least some artifacts of the plurality of artifacts; and
verifying the at least some artifacts at least by performing an error detection process prior to completion of the commit command.

13. The computer implemented method of claim 12, the act of initiating a software application release comprising:
automatically creating one or more branches for the software application release in response to one or more requests from the plurality of client computing systems; and
automatically tagging at least one newly created artifact of the plurality of artifacts with a packaging type.

14. The computer implemented method of claim 11, the process further comprising:
managing, at the release management module, the software application release by using at least the one or more box sets.

15. The computer implemented method of claim 14, the process further comprising:
performing a model driven deployment for the software application release at least by generating one or more release models or one or more release packages;
identifying at least one artifact of the plurality of artifacts or at least one box set of the one or more box sets with a packaging type;
generating software resources for the software application release; and
processing, at the release management module, the software resources for the software application release.

16. The computer implemented method of claim 15, the process further comprising:
accessing, at a common data access mechanism, data or information for the software application release; and
generating and tracking dependencies among at least some artifacts of the plurality of artifacts.

17. The computer implemented method of claim 11, the process further comprising:
developing, at one or more code development modules coupled to the plurality of client computing systems, the software application at least by creating one or more artifacts in the plurality of artifacts in a development environment.

18. The computer implemented method of claim 17, the process further comprising:
associating one or more packaging types with the one or more artifacts created in the development environment;
generating a project for at least the one or more artifacts using a project object model;
initiating a build process for the project;
setting up one or more testing environments;
identifying one or more tests;
executing the one or more tests in the one or more testing environments; and
generating and maintaining hierarchies for at least the one or more artifacts.

19. The computer implemented method of claim 11, the process further comprising:
performing software testing in one or more testing environments, comprising:
identifying one or more requirements for the software application; and
identifying one or more changes from a previous software application release of the software application prior to the software application release.

20. The computer implemented method of claim 19, the process further comprising:
determining a test strategy and a test plan;
determining one or more tests based in whole or in part upon the test strategy and the test plan;
determining a plurality of test cases and a plurality of test procedures for the one or more tests;
executing the one or more tests in the one or more testing environment;
analyzing results of executing the one or more tests; and
fixing one or more bugs and closing the one or more tests.

21. A computer program product comprising a non-transitory machine readable storage medium having stored thereupon at least a branch management module and a release management module which, when executed by a mobile communication device, causes one or more servers to perform a set of acts for implementing software development and releases, the set of acts comprising:
one or more server computers initiating a software application release for a software application at least by creating a branch, at the branch management module, for the software application release, the one or more server computers that are connected to a plurality of client computing devices via one or more computer networks and comprise at least a branch management module and a release management module;
the one or more computer servers automatically identifying a plurality of artifacts for the software application release based in part or in whole upon a plurality of packaging types associated with the plurality of artifacts;
the one or more computer servers automatically packaging the plurality of artifacts into one or more box sets for deployment into one or more corresponding environments for the software application release; and
the one or more computer servers deploying the one or more box sets into the one or more corresponding environments to complete the software application release.

22. The computer program product of claim 21, the set of acts further comprising:
the one or more computer servers identifying the branch with a common branch identifier visible to the plurality of client computing systems;
the one or more computer servers generating a project for the software application release;
the one or more computer servers initiating a build process for the project by using a project object model;
the one or more computer servers generating a snapshot by performing a database query in response to a commit command to store a state of at least some artifacts of the plurality of artifacts; and
the one or more computer servers verifying the at least some artifacts at least by performing an error detection process prior to completion of the commit command.

23. The computer program product of claim 22, the set of acts further comprising:
the one or more computer servers automatically creating one or more branches for the software application release in response to one or more requests from the plurality of client computing systems; and
the one or more computer servers automatically tagging at least one newly created artifact of the plurality of artifacts with a packaging type.

24. The computer program product of claim 21, the set of acts further comprising:
the one or more computer servers managing, at the release management module, the software application release by using at least the one or more box sets.

25. The computer program product of claim 24, the set of acts further comprising:
the one or more computer servers performing a model driven deployment for the software application release at least by generating one or more release models or one or more release packages;
the one or more computer servers identifying at least one artifact of the plurality of artifacts or at least one box set of the one or more box sets with a packaging type;
the one or more computer servers generating software resources for the software application release; and
the one or more computer servers processing, at the release management module, the software resources for the software application release.

26. The computer program product of claim 25, the set of acts further comprising:
the one or more computer servers accessing, at a common data access mechanism, data or information for the software application release; and
the one or more computer servers generating and tracking dependencies among at least some artifacts of the plurality of artifacts.

27. The computer program product of claim 21, the set of acts further comprising:
the one or more computer servers developing, at one or more code development modules coupled to the plurality of client computing systems, the software application at least by creating one or more artifacts in the plurality of artifacts in a development environment.

28. The computer program product of claim 27, the set of acts further comprising:
the one or more computer servers associating one or more packaging types with the one or more artifacts created in the development environment;
the one or more computer servers generating a project for at least the one or more artifacts using a project object model;
the one or more computer servers initiating a build process for the project;
the one or more computer servers setting up one or more testing environments;
the one or more computer servers identifying one or more tests;
the one or more computer servers executing the one or more tests in the one or more testing environments; and
the one or more computer servers generating and maintaining hierarchies for at least the one or more artifacts.

29. The computer program product of claim 21, the set of acts further comprising:
the one or more computer servers performing software testing in one or more testing environments, comprising:
the one or more computer servers identifying one or more requirements for the software application; and
the one or more computer servers identifying one or more changes from a previous software application release of the software application prior to the software application release.

30. The computer program product of claim 29, the set of acts further comprising:
the one or more computer servers determining a test strategy and a test plan;
the one or more computer servers determining one or more tests based in whole or in part upon the test strategy and the test plan;
the one or more computer servers determining a plurality of test cases and a plurality of test procedures for the one or more tests;
the one or more computer servers executing the one or more tests in the one or more testing environment;
the one or more computer servers analyzing results of executing the one or more tests; and
the one or more computer servers fixing one or more bugs and closing the one or more tests.
